(19) United States
(12) Patent Application Publication
(10) Pub. No.: US 2019/0102447 A1
(43) Pub. Date: Apr. 4, 2019

(54) SYSTEM AND METHOD FOR METADATA SANDBOXING AND WHAT-IF ANALYSIS IN A MULTIDIMENSIONAL DATABASE ENVIRONMENT

(71) Applicant: ORACLE INTERNATIONAL CORPORATION, Redwood Shores, CA (US)

(72) Inventor: Kumar Ramaiyer, Cupertino, CA (US)

(21) Appl. No.: 16/023,815

(22) Filed: Jun. 29, 2018

Related U.S. Application Data
(60) Provisional application No. 62/565,522, filed on Sep. 29, 2017.

(51) Int. Cl. G06F 17/30

(52) U.S. Cl. CPC G06F 17/30592; G06F 17/30563; G06F 17/30333; G06F 17/30327

(57) ABSTRACT

In accordance with an embodiment, described herein are systems and methods for supporting metadata sandboxing and what-if analysis in a multidimensional database, comprising. A system allow for various iterations of “what-if” analysis that allows users and administrators to test various situations and changing metadata relationships between data dimensions without altering a primary copy of the hierarchical data structure.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CLAIM OF PRIORITY

This application claims priority to U.S. Provisional patent application entitled “SYSTEM AND METHOD FOR METADATA SANDBOXING AND WHAT-IF ANALYSIS IN A MULTIDIMENSIONAL DATABASE ENVIRONMENT”, Application No. 62/565,522, filed on Sep. 29, 2017, which application is herein incorporated by reference.

### FIELD OF INVENTION

Embodiments of the invention are generally related to databases and data warehousing, and are particularly related to a system and method for supporting metadata sandboxing and what-if analysis in a multidimensional database environment.

### BACKGROUND

Multidimensional database computing environments enable companies to deliver critical business information to the right people when they need it, including the ability to leverage and integrate data from multiple existing data sources, and distribute filtered information to end-user communities in a format that best meets those users' needs. Users can interact with and explore data in real time, and along familiar business dimensions, enabling speed-of-thought analytics. These are some examples of the types of environment in which embodiments of the invention can be used.

### SUMMARY

In accordance with an embodiment, described herein are systems and methods f for supporting metadata sandboxing and what-if analysis in a multi-dimensional database, in accordance with an embodiment. A method can provide, at computer that includes one or more microprocessors, a multidimensional database server executing on the computer, wherein the multidimensional database server supports a hierarchical structure of a plurality data dimensions with a primary database. The method can provide a plurality of metadata relationships between each of the plurality of data dimensions. The method can receive a request at the multidimensional database server to perform one or more changes to the hierarchical structure of a plurality data dimensions within a sandbox database. Upon receiving the request, the method can generate a copy of the hierarchical data structure of the plurality of data dimensions. The method can place the generated copy of the hierarchical data structure of the plurality of data dimensions into the sandbox database, the sandbox database being supported by the multidimensional database server. The method, upon the copy of the hierarchical data structure of the plurality of data dimensions being placed into a metadata sandbox, can alter a metadata relationship of the plurality of metadata relationships between at least two of the plurality of data dimensions according to a received user input.

### BRIEF DESCRIPTION OF THE FIGURES

FIG. 1 illustrates an example of a multidimensional database environment, in accordance with an embodiment.

FIG. 2 shows an exemplary multidimensional database, where the database has a set of dimensions in a parent/child hierarchy in a recursive manner.

FIG. 3 shows an exemplary multidimensional database, where the database has a set of dimensions in a parent/child hierarchy in a recursive manner with metadata relationships between dimensions.

FIG. 4 shows an exemplary multidimensional database, where the database has a set of dimensions in a parent/child hierarchy in a recursive manner with metadata relationships between dimensions.

FIG. 5 shows a system for supporting metadata sandboxing and what-if analysis in a multi-dimensional database, in accordance with an embodiment.

FIG. 6 is a flowchart of a method for supporting metadata sandboxing and what-if analysis in a multi-dimensional database, in accordance with an embodiment.

### DETAILED DESCRIPTION

The foregoing, together with other features, will become apparent upon referring to the enclosed specification, claims, and drawings. Specific details are set forth in order to provide an understanding of various embodiments. However, it will be apparent that various embodiments may be practiced without these specific details. The enclosed specification and drawings are not intended to be restrictive.

Multidimensional database environments, an example of which includes Oracle Essbase, can be used to integrate large amounts of data, in some instances from multiple data sources, and distribute filtered information to end-users, in a manner that addresses those users' particular requirements.

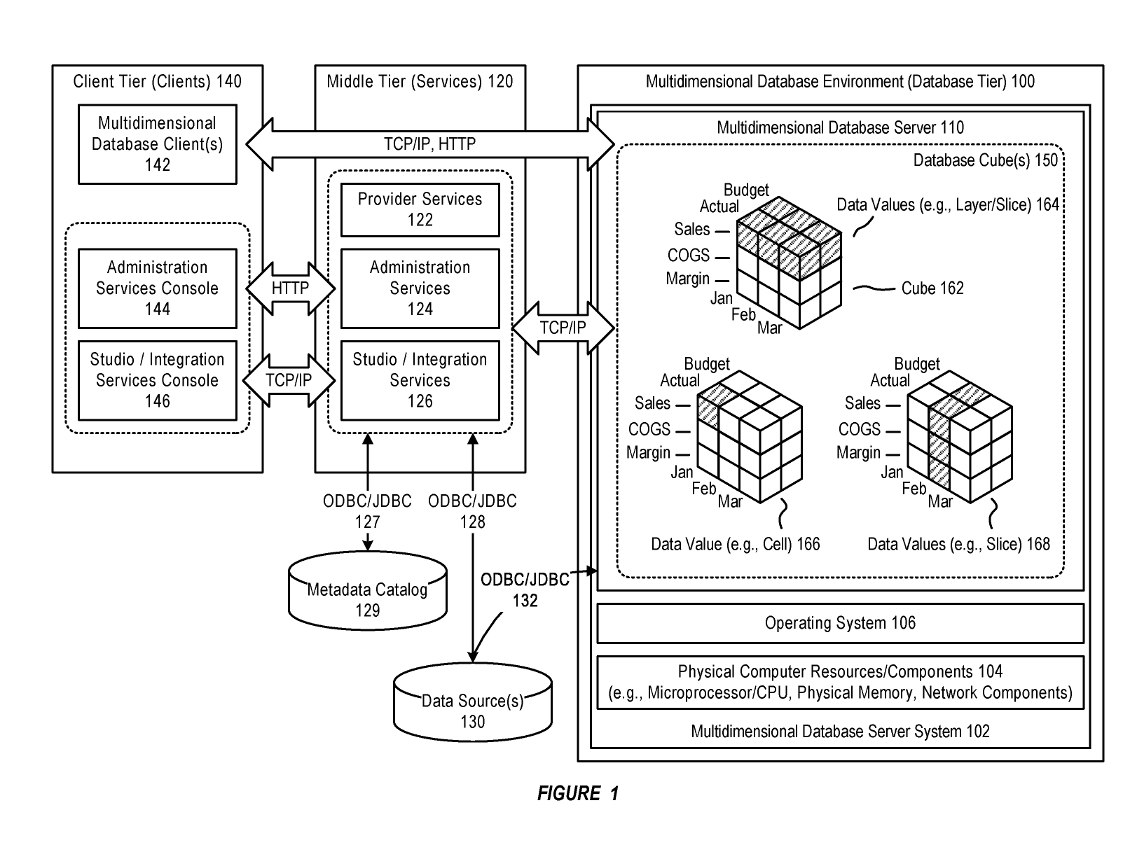

FIG. 1 illustrates an example of a multidimensional database environment 100, in accordance with an embodiment.

As illustrated in FIG. 1, in accordance with an embodiment, a multidimensional database environment, operating as a database tier, can include one or more multidimensional database server system(s) 102, each of which can include physical computer resources or components 104 (e.g., microprocessor/CPU, physical memory, network components), an operating system 106, and one or more multidimensional database server(s) 110 (e.g., Essbase Servers).

In accordance with an embodiment, a middle tier 120 can include one or more service(s), such as, for example, provider services 122 (e.g., Hyperion Provider Services), administration services 124 (e.g., Essbase Administration Services), or studio/integration services 126 (e.g., Essbase Studio/Essbase Integration Services). The middle tier can provide access, via ODBC/JDBC 127, 128, or other types of interfaces, to a metadata catalog 129, and/or one or more data source(s) 130 (for example, a relational database), for use with the multidimensional database environment.

In accordance with an embodiment, the one or more data source(s) can also be accessed, via ODBC/JDBC 132, or other types of interfaces, by the one or more multidimensional database server(s), for use in providing a multidimensional database.

In accordance with an embodiment, a client tier 140 can include one or more multidimensional database client(s) 142 (e.g., Essbase Server clients), that enable access to a multidimensional database (such as, for example, Smart View, Spreadsheet Add-in, Smart Search, Administration Services, MaxL, XMLA, CAPI or VB API Applications, Oracle Business Intelligence Enterprise Edition Plus, or other types of multidimensional database clients). The client tier can also include consoles, for use with services in the middle tier, such as for example an administration services console 144, or a studio/integration services console 146.

In accordance with an embodiment, communication between the client, middle, and database tiers can be provided by one or more of TCP/IP, HTTP, or other types of network communication protocols.

In accordance with an embodiment, the multidimensional database server can integrate data from the one or more data source(s), to provide a multidimensional database, data structure, or cube(s) 150, which can then be accessed to provide filtered information to end-users.

Generally, each data value in a multidimensional database is stored in one cell of a cube; and a particular data value can be referenced by specifying its coordinates along dimensions of the cube. The intersection of a member from one dimension, with a member from each of one or more other dimensions, represents a data value.

For example, as illustrated in FIG. 1, which illustrates a cube 162 that might be used in a sales-oriented business application, when a query indicates “Sales”, the system can interpret this query as a slice or layer of data values 164 within the database that contains all “Sales” data values, where “Sales” intersect with “Actual” and “Budget”. To refer to a specific data value 166 in a multidimensional database, the query can specify a member on each dimension, for example by specifying “Sales, Actual, January”. Slicing the database in different ways, provides different perspectives of the data; for example, a slice of data values 168 for “February” examines all of those data values for which a time/year dimension is fixed for “February”.

### Database Outline

In accordance with an embodiment, development of a multidimensional database begins with the creation of a database outline, which defines structural relationships between members in the database; organizes data in the database; and defines consolidations and mathematical relationships. Within the hierarchical tree or data structure of the database outline, each dimension comprises one or more members, which in turn may comprise other members. The specification of a dimension instructs the system how to consolidate the values of its individual members. A consolidation is a group of members within a branch of the tree.

### Dimensions and Members

In accordance with an embodiment, a dimension represents the highest consolidation level in the database outline. Standard dimensions may be chosen to represent components of a business plan that relate to departmental functions (e.g., Time, Accounts, Product Line, Market, Division). Attribute dimensions, that are associated with standard dimensions, enable a user to group and analyze members of standard dimensions based on member attributes or characteristics. Members (e.g., Product A, Product B, Product C) are the individual components of a dimension.

### Dimension and Member Relationships

In accordance with an embodiment, a multidimensional database uses family (parents, children, siblings; descendants and ancestors); and hierarchical (generations and levels; roots and leaves) terms, to describe the roles and relationships of the members within a database outline.

In accordance with an embodiment, a parent is a member that has a branch below it. For example, “Margin” may be a parent for “Sales”, and “Cost of Goods Sold” (COGS). A child is a member that has a parent above it. In the above example, “Sales” and “Cost of Goods Sold” are children of the parent “Margin”. Siblings are children of the same immediate parent, within the same generation.

In accordance with an embodiment, descendants are members in branches below a parent. For example, “Profit”, “Inventory”, and “Ratios” may be descendants of Measures; in which case the children of “Profit”, “Inventory”, and “Ratios” are also descendants of Measures. Ancestors are members in branches above a member. In the above example, “Margin”, “Profit”, and Measures may be ancestors of “Sales”.

In accordance with an embodiment, a root is the top member in a branch. For example, Measures may be the root for “Profit”, “Inventory”, and “Ratios”; and as such for the children of “Profit”, “Inventory”, and “Ratios”. Leaf (level 0) members have no children. For example, Opening “Inventory”, Additions, and Ending “Inventory” may be leaf members.

In accordance with an embodiment, a generation refers to a consolidation level within a dimension. The root branch of the tree is considered to be “generation 1”, and generation numbers increase from the root toward a leaf member. Level refers to a branch within a dimension; and are numbered in reverse from the numerical ordering used for generations, with level numbers decreasing from a leaf member toward its root.

In accordance with an embodiment, a user can assign a name to a generation or level, and use that name as a shorthand for all members in that generation or level.

### Sparse and Dense Dimensions

Data sets within a multidimensional database often share two characteristics: the data is not smoothly and uniformly distributed; and data does not exist for a majority of member combinations.

In accordance with an embodiment, to address this, the system can recognize two types of standard dimensions: sparse dimensions and dense dimensions. A sparse dimension is one with a relatively low percentage of available data positions filled; while a dense dimension is one in which there is a relatively high probability that one or more cells is occupied in every combination of dimensions. Many multidimensional databases are inherently sparse, in that they lack data values for the majority of member combinations.

### Data Blocks and the Index System

In accordance with an embodiment, the multidimensional database uses data blocks and an index to store and access data. The system can create a multidimensional array or data block for each unique combination of sparse standard dimension members, wherein each data block represents the dense dimension members for its combination of sparse dimension members. An index is created for each data block, wherein the index represents the combinations of sparse standard dimension members, and includes an entry or pointer for each unique combination of sparse standard dimension members for which at least one data value exists.

In accordance with an embodiment, when the multidimensional database server searches for a data value, it can use the pointers provided by the index, to locate the appropriate data block; and, within that data block, locate the cell containing the data value.

### Administration Services

In accordance with an embodiment, an administration service (e.g., Essbase Administration Services) provides a single-point-of-access that enables a user to design, develop, maintain, and manage servers, applications, and databases.

### Studio

In accordance with an embodiment, a studio (e.g., Essbase Studio) provides a wizard-driven user interface for performing tasks related to data modeling, cube designing, and analytic application construction.

### Spreadsheet Add-in

In accordance with an embodiment, a spreadsheet add-in integrates the multidimensional database with a spreadsheet, which provides support for enhanced commands such as Connect, Pivot, Drill-down, and Calculate.

### Integration Services

In accordance with an embodiment, an integration service (e.g., Essbase Integration Services), provides a metadata-driven environment for use in integrating between the data stored in a multidimensional database and data stored in relational databases.

### Provider Services

In accordance with an embodiment, a provider service (e.g., Hyperion Provider Services) operates as a data-source provider for Java API, Smart View, and XMLA clients.

### Smart View

In accordance with an embodiment, a smart view provides a common interface for, e.g., Hyperion Financial Management, Hyperion Planning, and Hyperion Enterprise Performance Management Workspace data.

### Developer Products

In accordance with an embodiment, developer products enable the rapid creation, management, and deployment of tailored enterprise analytic applications.

### Lifecycle Management

In accordance with an embodiment, a lifecycle management (e.g., Hyperion Enterprise Performance Management System Lifecycle Management) provides a means for enabling enterprise performance management products to migrate an application, repository, or individual artifacts across product environments.

### OLAP

In accordance with an embodiment, online analytical processing (OLAP) provides an environment that enables users to analyze enterprise data. For example, finance departments can use OLAP for applications such as budgeting, activity-based costing, financial performance analysis, and financial modeling, to provide “just-in-time” information.

In accordance with an embodiment, OLAP systems can organize data in multiple dimensions allows searchers/users of the data set to conduct directed searches that traverse various dimensions to ultimately arrive at the result of interest. OLAP systems can view data as residing at the intersection of dimensions. Put another way, the data underlying OLAP systems can be organized and stored as a multi-dimensional database which is an instantiation of the cross-product of all of the dimensions. This allows users/searchers to traverse hierarchies of detail along dimensions of interest in an ad hoc manner to get at specific, targeted data. Slowly changing data can be represented as metadata within a current data set.

### Metadata Sandboxing and What-if Analysis

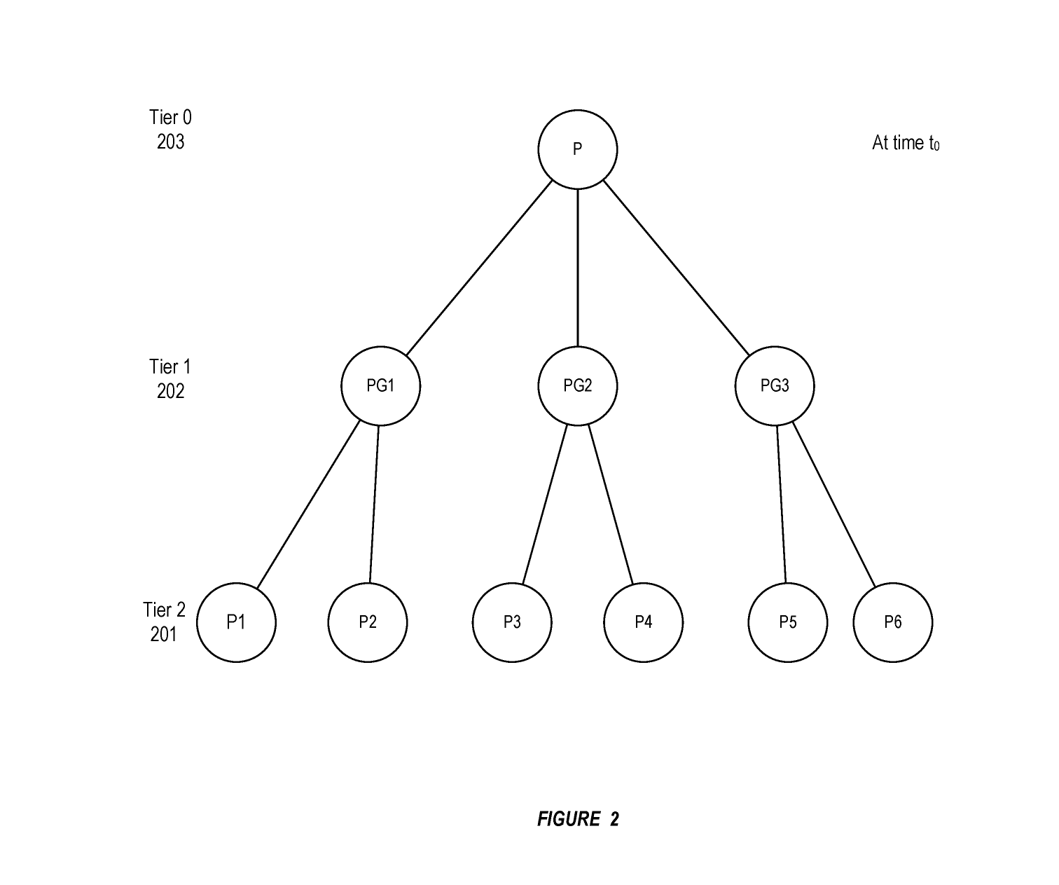

An exemplary multidimensional database, where the database has a set of dimensions in a parent/child hierarchy in a recursive manner, is shown in FIG. 2.

FIG. 2 shows an exemplary hierarchal data structure having three tiers, tier 0 203, tier 1 202, and tier 2 201. In accordance with an embodiment, for example, tier 0 can contain dimension P.

Tier 1 can contain a number of dimensions as well, such as PG1, PG2, and PG3, which are associated with the dimension P via the links shown in FIG. 2. These links can represent, for example, metadata that shows an association between the dimension P (a parent dimension with respect to the dimensions of Tier 1), and dimensions PG1, PG2 and PG3.

Tier 2 can contain a number of dimensions as well, such as P1, P2, P3, P4, P5, and P6, which are associated with the dimensions P1, P2, and P3 (respectively) via the links shown in FIG. 2. These links can represent, for example, metadata that shows an association between the dimensions PG1, PG2, and PG3 (parent dimensions with respect to the dimensions of Tier 2), and dimensions PG1, PG2 and PG3.

In accordance with an embodiment, the hierarchal data structure having three tiers shown in FIG. 2 can represent an initial point at time t₀, which can represent, for example, an initial load of data into a database.

In accordance with an embodiment, the data dimensions (i.e., P, PG1-3, and P1-6) can be associated via links, which can be embodied by metadata.

In accordance with an embodiment, the dimensions can be representative of various pieces of data. For example, dimension P can represent a product family. Dimensions PG1-PG3 can represent different product groups. Dimensions P1-P6 can represent different products.

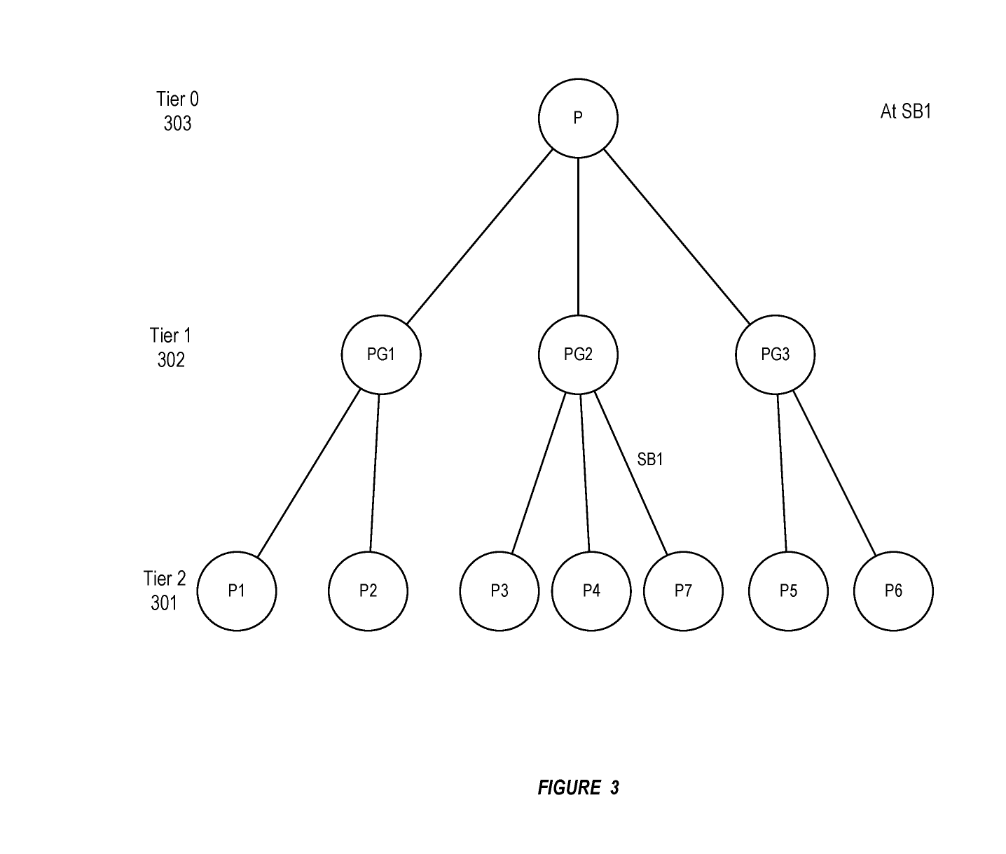

An exemplary multidimensional database, where the database has a set of dimensions in a parent/child hierarchy in a recursive manner with metadata relationships between dimensions, is shown in FIG. 3.

In accordance with an embodiment, FIG. 3 shows an exemplary hierarchal data structure having three tiers, tier 0 303, tier 1 302, and tier 2 301. In accordance with an embodiment, for example, tier 0 can contain dimension P.

Tier 1 can contain a number of dimensions as well, such as PG1, PG2, and PG3, which are associated with the dimension P via the links shown in FIG. 3. These links can represent, for example, metadata that shows an association between the dimension P (a parent dimension with respect to the dimensions of Tier 1), and dimensions PG1, PG2 and PG3.

Tier 2 can contain a number of dimensions as well, such as P1, P2, P3, P4, P5, P6, and P7 which are associated with the dimensions P1, P2, and P3 (respectively) via the links shown in FIG. 3. These links can represent, for example, metadata that shows an association between the dimensions PG1, PG2, and PG3 (parent dimensions with respect to the dimensions of Tier 2), and dimensions PG1, PG2 and PG3.

In accordance with an embodiment, the hierarchal data structure having three tiers shown can be altered, within a sandbox environment, by a user, such as an administrator or other end user. Such a sandbox can alter, for example, the metadata relationships between the data dimensions. This is shown as SB1 (sandbox 1) wherein the SB1 relationship indicates that metadata between dimension PG2 and P7 have been added/altered by a user to indicate, for example, a test that such user would like to run.

In accordance with an embodiment, the sandboxing shown in FIG. 3 represents the addition of a dimension to tier 2 301, namely dimension P7. This sandboxed relationship is represented in the Figure as a line connecting P7 to PG2, which is representative of a metadata relationship between the two dimensions.

In accordance with an embodiment, this metadata relationship SB1 is wholly contained in a sandbox environment and is not pushed to a live/current version of the hierarchal data structure (unless a command is received to the contrary).

In accordance with an embodiment, within a sandbox environment, the deletion, addition, or modification of a metadata relationship can, in addition to metadata already associated with the link (e.g., a weighted relationship), be marked with a tag indicating that such relationship is only valid within the sandbox environment.

Such tests, for example, can be run to model or predict how a change in a metadata relationship between dimensions could affect the overall data structure. Importantly, such a sandbox based approach does not actually alter a main version of the data structure, but instead allows such “tests” to be performed in a sandbox, where the sandbox allows for metadata to be altered/updated in an environment that won't be pushed (unless a command is entered) to a current/live version of the data structure.

As an example, in retail industry, there is typically a hierarchy of dimensions, such as product family (P), product groups (PG1, PG2, and PG3), and products (P1-P7). Based on certain metrics, a user can compute and rank how well certain products are being sold. Users can compute different rankings for different products. These computations/rankings . . . etc. are all data dimensions. However, a user may wish to change a metadata relationship between dimensions to see how different factors could change product ranking.

As an example, certain products may be sold both in an online storefront and within a brick and mortar store, while other products may be sold exclusively in a brick and mortar store. While items sold exclusively in a brick and mortar store may hold a high product rank, certain factors, represented by metadata between the dimensions of the data structure, may influence a product's rank.

For example, if a heavy winter storm is forecast prior to a busy holiday shopping weekend, this may influence the traffic to a brick and mortar store front. By sandboxing such metadata changes, a user can predict how a product's rank may fall (e.g., the product only sold in a brick and mortar store), while another product's rank may rise (e.g., the product sold both online and in a brick and mortar store).

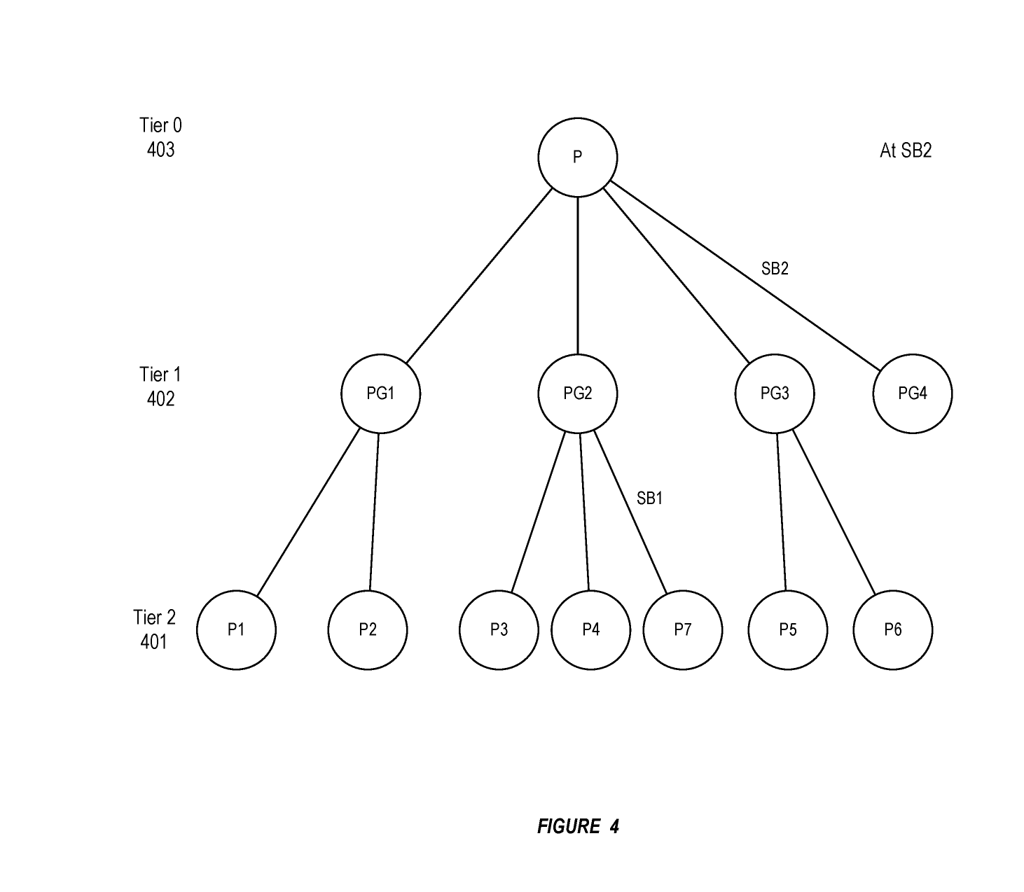

An exemplary multidimensional database, where the database has a set of dimensions in a parent/child hierarchy in a recursive manner with metadata relationships between dimensions, is shown in FIG. 4.

FIG. 4 shows an exemplary hierarchal data structure having three tiers, tier 0 401, tier 1 402, and tier 2 403. In accordance with an embodiment, for example, tier 0 can contain dimension P.

In accordance with an embodiment, Tier 1 can contain a number of dimensions as well, such as PG1, PG2, and PG3, which are associated with the dimension P via the links shown in FIG. 4. These links can represent, for example, metadata that shows an association between the dimension P (a parent dimension with respect to the dimensions of Tier 1), and dimensions PG1, PG2 and PG3.

In accordance with an embodiment, Tier 2 can contain a number of dimensions as well, such as P1, P2, P3, P4, P5, P6, and P7 which are associated with the dimensions P1, P2, and P3 (respectively) via the links shown in FIG. 4. These links can represent, for example, metadata that shows an association between the dimensions PG1, PG2, and PG3 (parent dimensions with respect to the dimensions of Tier 2), and dimensions PG1, PG2 and PG3.

In accordance with an embodiment, the hierarchal data structure having three tiers shown can be altered, within a sandbox environment, by a user, such as an administrator or other user. With such a sandbox, for example, the metadata relationships between the data dimensions can be altered to allow a user to understand how the various dimensions may change based upon the addition/deletion/modification of a metadata relationship(s) and/or the addition or deletion of a data dimension(s). This is shown in FIG. 4 at SB2 (sandbox 2), which incorporates a prior metadata sandbox, SB1 (sandbox 1). Both SB2 and SB1 indicate that metadata between various dimensions have been altered by a user to indicate, for example, a test that such user would like to run.

In accordance with an embodiment, within a sandbox environment, the deletion, addition, or modification of a metadata relationship can, in addition to metadata already associated with the link (e.g., a weighted relationship), be marked with a tag indicating that such relationship is only valid within the sandbox environment.

In accordance with an embodiment, as shown in the Figure, metadata sandboxing is supported recursively, wherein multiple sandboxes can account for prior sandboxing of metadata between dimensions in the data structure.

Both FIGS. 3 and 4 then allow for various iterations of “what-if” analysis that allows users and administrators to test various situations and changing metadata relationships between data dimensions without altering a primary copy of the hierarchical data structure.

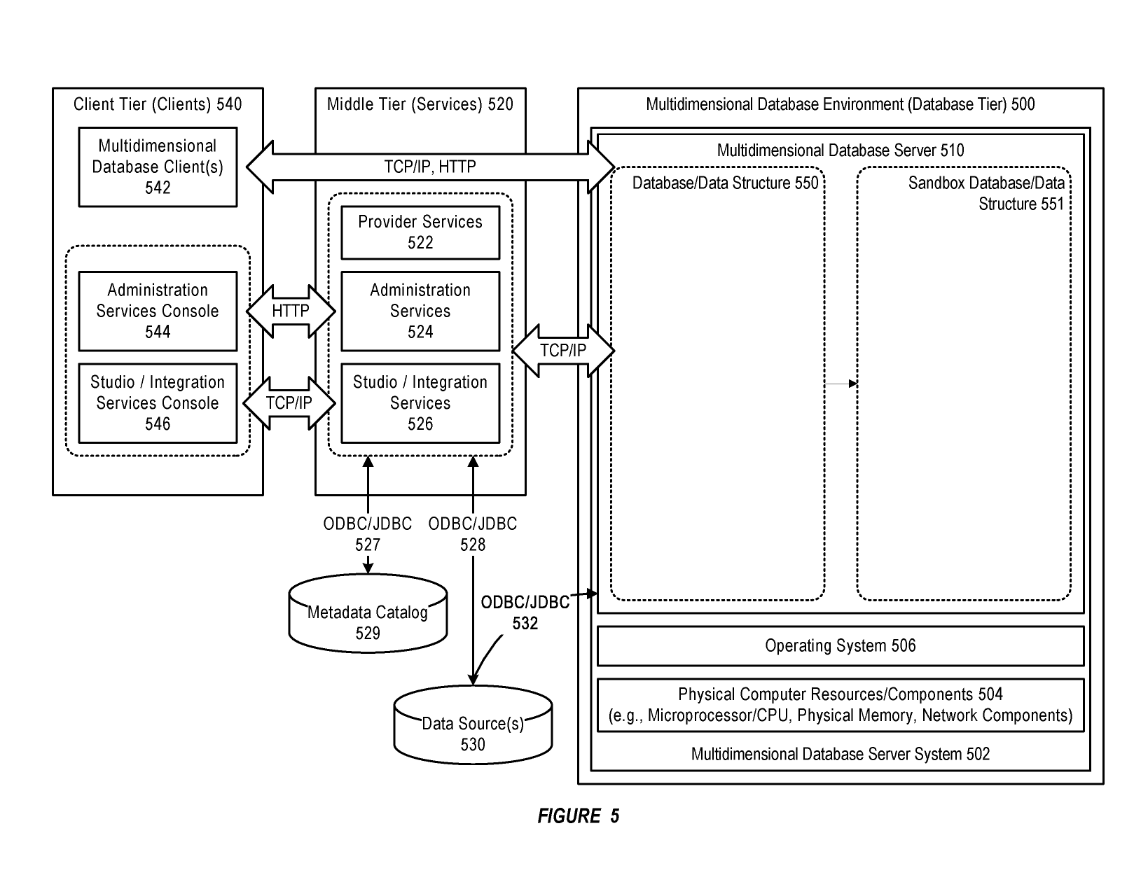

FIG. 5 shows a system for supporting metadata sandboxing and what-if analysis in a multi-dimensional database, in accordance with an embodiment.

As illustrated in FIG. 5, in accordance with an embodiment, a multidimensional database environment, operating as a database tier, can include one or more multidimensional database server system(s) 502, each of which can include physical computer resources or components 504 (e.g., microprocessor/CPU, physical memory, network components), an operating system 506, and one or more multidimensional database server(s) 510 (e.g., Essbase Servers).

In accordance with an embodiment, a middle tier 520 can include one or more service(s), such as, for example, provider services 522 (e.g., Hyperion Provider Services), administration services 524 (e.g., Essbase Administration Services), or studio/integration services 526 (e.g., Essbase Studio/Essbase Integration Services). The middle tier can provide access, via ODBC/JDBC 527, 528, or other types of interfaces, to a metadata catalog 529, and/or one or more data source(s) 530 (for example, a relational database), for use with the multidimensional database environment.

In accordance with an embodiment, the one or more data source(s) can also be accessed, via ODBC/JDBC 532, or other types of interfaces, by the one or more multidimensional database server(s), for use in providing a multidimensional database.

In accordance with an embodiment, a client tier 540 can include one or more multidimensional database client(s) 542 (e.g., Essbase Server clients), that enable access to a multidimensional database (such as, for example, Smart View, Spreadsheet Add-in, Smart Search, Administration Services, MaxL, XMLA, CAPI or VB API Applications, Oracle Business Intelligence Enterprise Edition Plus, or other types of multidimensional database clients). The client tier can also include consoles, for use with services in the middle tier, such as for example an administration services console 544, or a studio/integration services console 546.

In accordance with an embodiment, communication between the client, middle, and database tiers can be provided by one or more of TCP/IP, HTTP, or other types of network communication protocols.

In accordance with an embodiment, the multidimensional database server can integrate data from the one or more data source(s), to provide a multidimensional database, data structure, or cube(s) 550, which can then be accessed to provide filtered information to end-users.

Generally, each data value in a multidimensional database is stored in one cell of a cube; and a particular data value can be referenced by specifying its coordinates along dimensions of the cube. The intersection of a member from one dimension, with a member from each of one or more other dimensions, represents a data value.

In accordance with an embodiment, a multidimensional data structure can be stored in the database/data structure 550. The multidimensional database server 510 can additionally support one or more sandbox database/data structure 551 (while only one sandbox is shown in the Figure, the database server 510 can support a plurality of sandboxes for use, for example, by different users and/or for recursive sandboxing).

In accordance with an embodiment, the database 550 can support a number of data structures, including multidimensional database cubes and multidimensional data structures. When a sandbox environment is to be used (for example, for a “what if” scenario), a copy (e.g., a current copy or a previous copy) of the data structure is populated into the sandbox database 551.

In accordance with an embodiment, then, a user can perform “what if” analyses within the sandbox database 551 via the traditional mechanisms (e.g., through the client tier and the middle tier). This then allows a user to see how a modification of an existing data structure can alter the totality of the data structure without resulting in the original copy of the data structure being changed.

In accordance with an embodiment, when a recursive sandbox is desired, a copy of the data structure from a current sandbox can be copied into a new sandbox environment. Alternatively, a single copy of the sandboxed data structure can be maintained wherein each recursive sandbox operation is tagged, via metadata, to indicate a sequential nature of alterations/modifications.

In accordance with an embodiment, the data structure within the sandbox database 551 is deleted upon closing of the sandbox database 551, unless a command to persist such database is received, or unless a command to replace the current version of the data structure within database 550 with that from sandbox database 551 is received. Upon receiving such a first request, the sandboxed data structure can be stored for future retrieval. Upon receiving such a second request, the sandboxed data structure is copied back to the database 550 where it replaces the original data structure.

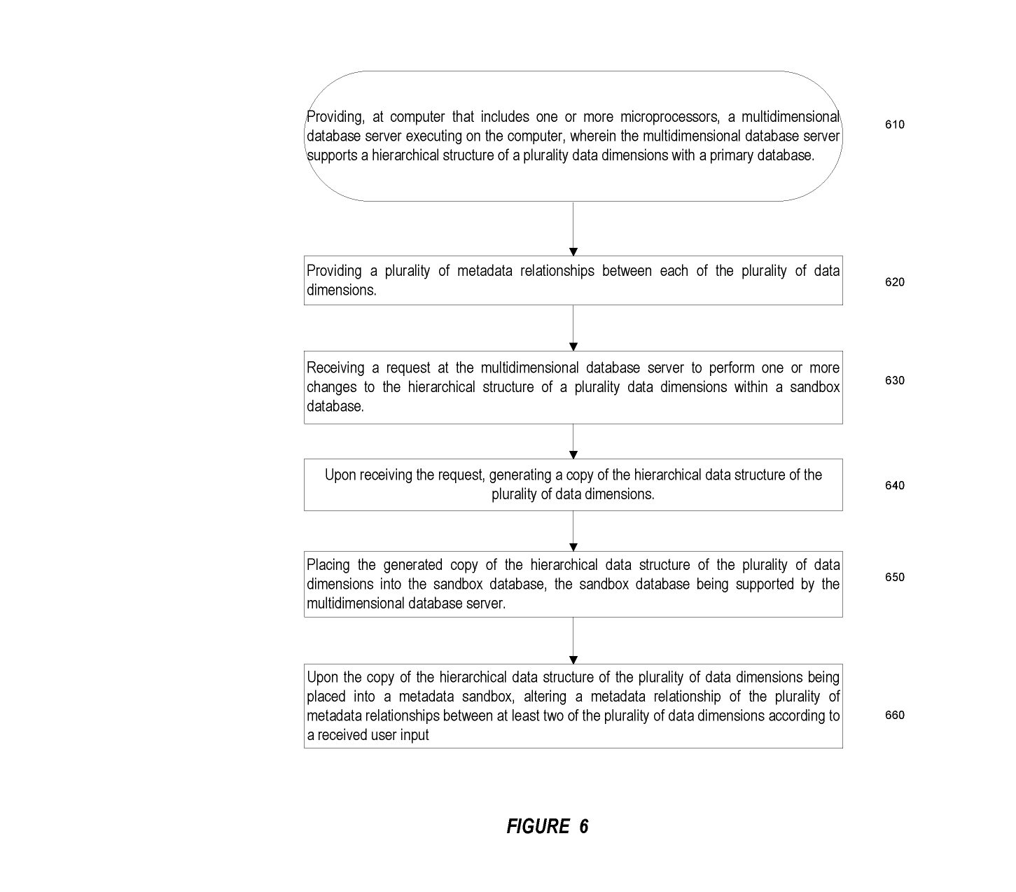

FIG. 6 is a flowchart of a method for supporting metadata sandboxing and what-if analysis in a multi-dimensional database, in accordance with an embodiment.

At step 610, the method can provide, at computer that includes one or more microprocessors, a multidimensional database server executing on the computer, wherein the multidimensional database server supports a hierarchical structure of a plurality data dimensions with a primary database.

At step 620, the method can provide a plurality of metadata relationships between each of the plurality of data dimensions.

At step 630, the method can receive a request at the multidimensional database server to perform one or more changes to the hierarchical structure of a plurality data dimensions within a sandbox database.

At step 640, upon receiving the request, the method can generate a copy of the hierarchical data structure of the plurality of data dimensions.

At step 650, the method can place the generated copy of the hierarchical data structure of the plurality of data dimensions into the sandbox database, the sandbox database being supported by the multidimensional database server.

At step 660, upon the copy of the hierarchical data structure of the plurality of data dimensions being placed into a metadata sandbox, the method can alter a metadata relationship of the plurality of metadata relationships between at least two of the plurality of data dimensions according to a received user input.

While various embodiments of the present invention have been described above, it should be understood that they have been presented by way of example, and not limitation. The embodiments were chosen and described in order to explain the principles of the invention and its practical application. The embodiments illustrate systems and methods in which the present invention is utilized to improve the performance of the systems and methods by providing new and/or improved features and/or providing benefits such as reduced resource utilization, increased capacity, improved efficiency, and reduced latency.

In some embodiments, features of the present invention are implemented, in whole or in part, in a computer including a processor, a storage medium such as a memory and a network card for communicating with other computers. In some embodiments, features of the invention are implemented in a distributed computing environment in which one or more clusters of computers is connected by a network such as a Local Area Network (LAN), switch fabric network (e.g. InfiniBand), or Wide Area Network (WAN). The distributed computing environment can have all computers at a single location or have clusters of computers at different remote geographic locations connected by a WAN.

In some embodiments, features of the present invention are implemented, in whole or in part, in the cloud as part of, or as a service of, a cloud computing system based on shared, elastic resources delivered to users in a self-service, metered manner using Web technologies. There are five characteristics of the cloud (as defined by the National Institute of Standards and Technology: on-demand self-service; broad network access; resource pooling; rapid elasticity; and measured service. See, e.g. “The NIST Definition of Cloud Computing”, Special Publication 800-145 (2011) which is incorporated herein by reference. Cloud deployment models include: Public, Private, and Hybrid. Cloud service models include Software as a Service (SaaS), Platform as a Service (PaaS), Database as a Service (DBaaS), and Infrastructure as a Service (IaaS). As used herein, the cloud is the combination of hardware, software, network, and web technologies which delivers shared elastic resources to users in a self-service, metered manner. Unless otherwise specified the cloud, as used herein, encompasses public cloud, private cloud, and hybrid cloud embodiments, and all cloud deployment models including, but not limited to, cloud SaaS, cloud DBaaS, cloud PaaS, and cloud IaaS.

In some embodiments, features of the present invention are implemented using, or with the assistance of hardware, software, firmware, or combinations thereof. In some embodiments, features of the present invention are implemented using a processor configured or programmed to execute one or more functions of the present invention. The processor is in some embodiments a single or multi-chip processor, a digital signal processor (DSP), a system on a chip (SOC), an application specific integrated circuit (ASIC), a field programmable gate array (FPGA) or other programmable logic device, state machine, discrete gate or transistor logic, discrete hardware components, or any combination thereof designed to perform the functions described herein. In some implementations, features of the present invention may be implemented by circuitry that is specific to a given function. In other implementations, the features may implemented in a processor configured to perform particular functions using instructions stored e.g. on a computer readable storage media.

In some embodiments, features of the present invention are incorporated in software and/or firmware for controlling the hardware of a processing and/or networking system, and for enabling a processor and/or network to interact with other systems utilizing the features of the present invention. Such software or firmware may include, but is not limited to, application code, device drivers, operating systems, virtual machines, hypervisors, application programming interfaces, programming languages, and execution environments/containers. Appropriate software coding can readily be prepared by skilled programmers based on the teachings of the present disclosure, as will be apparent to those skilled in the software art.

In some embodiments, the present invention includes a computer program product which is a storage medium or computer-readable medium (media) having instructions stored thereon/in, which instructions can be used to program or otherwise configure a system such as a computer to perform any of the processes or functions of the present invention. The storage medium or computer readable medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. In particular embodiments, the storage medium or computer readable medium is a non-transitory storage medium or non-transitory computer readable medium.

The foregoing description is not intended to be exhaustive or to limit the invention to the precise forms disclosed. Additionally, where embodiments of the present invention have been described using a particular series of transactions and steps, it should be apparent to those skilled in the art that the scope of the present invention is not limited to the described series of transactions and steps. Further, where embodiments of the present invention have been described using a particular combination of hardware and software, it should be recognized that other combinations of hardware and software are also within the scope of the present invention. Further, while the various embodiments describe particular combinations of features of the invention it should be understood that different combinations of the features will be apparent to persons skilled in the relevant art as within the scope of the invention such that features of one embodiment may incorporated into another embodiment. Moreover, it will be apparent to persons skilled in the relevant art that various additions, subtractions, deletions, variations, and other modifications and changes in form, detail, implementation and application can be made therein without departing from the spirit and scope of the invention. It is intended that the broader spirit and scope of the invention be defined by the following claims and their equivalents.

What is claimed is:

1. A system for supporting metadata sandboxing and what-if analysis in a multidimensional database, comprising:
a computer that includes one or more microprocessors;
a multidimensional database server executing on the computer, wherein the multidimensional database server supports a hierarchical structure of a plurality data dimensions with a primary database;
wherein a plurality of metadata relationships are provided between each of the plurality of data dimensions;
wherein a request is received at the multidimensional database server to perform one or more changes to the hierarchical structure of a plurality data dimensions within a sandbox database;
wherein, upon receiving the request, a copy of the hierarchical data structure of the plurality of data dimensions is made and placed into the sandbox database, the sandbox database being supported by the multidimensional database server;
wherein upon the copy of the hierarchical data structure of the plurality of data dimensions being placed into a metadata sandbox, altering a metadata relationship of the plurality of metadata relationships between at least two of the plurality of data dimensions according to a received user input.

2. The system of claim 1,
wherein upon the copy of the hierarchical data structure of the plurality of data dimensions being placed into the metadata sandbox, adding another metadata relationship to the plurality of metadata relationships, the another metadata relationship being associated with another data dimension of the plurality of data dimensions and a new data dimension, the new data dimension being added to the hierarchical structure of the plurality of data dimensions, based upon the received user input.

3. The system of claim 2, wherein a second user input is received;
wherein a second metadata relationship of the plurality of metadata relationships between at least another two of the plurality of data dimensions is altered according to a received user input.

4. The system of claim 3,
wherein the alteration of the metadata relationship of the plurality of metadata relationships between the at least two of the plurality of data dimensions according to the received user input is marked with metadata indicative of an association with the received user input.

5. The system of claim 4,
wherein the alteration of the second metadata relationship of the plurality of metadata relationships between the at least another two of the plurality of data dimensions according to the received user input is marked with metadata indicative of an association with the second received user input.

6. The system of claim 5,
wherein, based upon a received user command, the copy of the hierarchical data structure replaces the hierarchical structure of a plurality data dimensions at the multidimensional database server executing on the computer.

7. The system of claim 1,
wherein upon the copy of the hierarchical data structure of the plurality of data dimensions being placed into the metadata sandbox, deleting another metadata relationship of the plurality of metadata relationships, the another metadata relationship being associated with at least another two of the plurality of data dimensions, based upon the received user input.

8. A method for supporting metadata sandboxing and what-if analysis in a multidimensional database, comprising:
providing, at computer that includes one or more microprocessors, a multidimensional database server executing on the computer, wherein the multidimensional database server supports a hierarchical structure of a plurality data dimensions with a primary database;
providing a plurality of metadata relationships between each of the plurality of data dimensions;
receiving a request at the multidimensional database server to perform one or more changes to the hierarchical structure of a plurality data dimensions within a sandbox database;
upon receiving the request, generating a copy of the hierarchical data structure of the plurality of data dimensions;
placing the generated copy of the hierarchical data structure of the plurality of data dimensions into the sandbox database, the sandbox database being supported by the multidimensional database server;
upon the copy of the hierarchical data structure of the plurality of data dimensions being placed into a metadata sandbox, altering a metadata relationship of the plurality of metadata relationships between at least two of the plurality of data dimensions according to a received user input.

9. The method of claim 8,
wherein upon the copy of the hierarchical data structure of the plurality of data dimensions being placed into the metadata sandbox, adding another metadata relationship to the plurality of metadata relationships, the another metadata relationship being associated with another data dimension of the plurality of data dimensions and a new data dimension, the new data dimension being added to the hierarchical structure of the plurality of data dimensions, based upon the received user input.

10. The method of claim 9, wherein a second user input is received;
wherein a second metadata relationship of the plurality of metadata relationships between at least another two of the plurality of data dimensions is altered according to a received user input.

11. The method of claim 10,
wherein the alteration of the metadata relationship of the plurality of metadata relationships between the at least two of the plurality of data dimensions according to the received user input is marked with metadata indicative of an association with the received user input.

12. The method of claim 1,
wherein the alteration of the second metadata relationship of the plurality of metadata relationships between the at least another two of the plurality of data dimensions according to the received user input is marked with metadata indicative of an association with the second received user input.

13. The method of claim 12,
wherein, based upon a received user command, the copy of the hierarchical data structure replaces the hierarchical structure of a plurality data dimensions at the multidimensional database server executing on the computer.

14. The method of claim 8,
wherein upon the copy of the hierarchical data structure of the plurality of data dimensions being placed into the metadata sandbox, deleting another metadata relationship of the plurality of metadata relationships, the another metadata relationship being associated with at least another two of the plurality of data dimensions, based upon the received user input.

15. A non-transitory computer readable storage medium having instructions thereon for supporting metadata sandboxing and what-if analysis in a multidimensional database, which when read and executed cause a computer to perform steps comprising:
providing, at computer that includes one or more microprocessors, a multidimensional database server executing on the computer, wherein the multidimensional database server supports a hierarchical structure of a plurality data dimensions with a primary database;
providing a plurality of metadata relationships between each of the plurality of data dimensions;
receiving a request at the multidimensional database server to perform one or more changes to the hierarchical structure of a plurality data dimensions within a sandbox database;
upon receiving the request, generating a copy of the hierarchical data structure of the plurality of data dimensions;
placing the generated copy of the hierarchical data structure of the plurality of data dimensions into the sandbox database, the sandbox database being supported by the multidimensional database server;
upon the copy of the hierarchical data structure of the plurality of data dimensions being placed into a metadata sandbox, altering a metadata relationship of the plurality of metadata relationships between at least two of the plurality of data dimensions according to a received user input.

16. The non-transitory computer readable storage medium of claim 15,
wherein upon the copy of the hierarchical data structure of the plurality of data dimensions being placed into the metadata sandbox, adding another metadata relationship to the plurality of metadata relationships, the another metadata relationship being associated with another data dimension of the plurality of data dimensions and a new data dimension, the new data dimension being added to the hierarchical structure of the plurality of data dimensions, based upon the received user input.

17. The non-transitory computer readable storage medium of claim 16, wherein a second user input is received;
wherein a second metadata relationship of the plurality of metadata relationships between at least another two of the plurality of data dimensions is altered according to a received user input.

18. The non-transitory computer readable storage medium of claim 17,
wherein the alteration of the metadata relationship of the plurality of metadata relationships between the at least two of the plurality of data dimensions according to the received user input is marked with metadata indicative of an association with the received user input.

19. The non-transitory computer readable storage medium of claim 18,
wherein the alteration of the second metadata relationship of the plurality of metadata relationships between the at least another two of the plurality of data dimensions according to the received user input is marked with metadata indicative of an association with the second received user input.

20. The non-transitory computer readable storage medium of claim 19,
wherein, based upon a received user command, the copy of the hierarchical data structure replaces the hierarchical structure of a plurality data dimensions at the multidimensional database server executing on the computer.
